(19) United States
(12) Patent Application Publication
(10) Pub. No.: US 2023/0276127 A1
(43) Pub. Date: Aug. 31, 2023

(54) IMAGE PROCESSING APPARATUS AND IMAGE PROCESSING METHOD

(71) Applicant: CANON KABUSHIKI KAISHA, Tokyo (JP)

(72) Inventor: KAORI TAJIMA, Tokyo (JP)

(21) Appl. No.: 18/172,725

(22) Filed: Feb. 22, 2023

(30) Foreign Application Priority Data
Feb. 28, 2022 (JP) 2022-030258

(51) Int. Cl. H04N 23/68; G06T 5/50; G06T 7/246; G06V 10/25; G06V 10/44

(52) U.S. Cl. CPC H04N 23/6845; G06T 5/50; G06T 7/246; G06V 10/25; G06V 10/44; G06T 2207/20201; G06T 2207/20104; G06T 2207/20221

(57) ABSTRACT

An apparatus includes at least one processor and a memory that stores a program which, when executed by the at least one processor, causes the at least one processor to function as an acquisition unit configured to acquire an image, a region determination unit configured to determine a plurality of subject regions in the image, and a combining unit configured to combine a plurality of images obtained by an imaging unit configured to perform image capturing under a predetermined imaging condition, wherein the combining unit has different subject blur correction characteristics corresponding to features of the plurality of subject regions, and performs a combining process with reference to the different subject blur correction characteristics in the plurality of subject regions.

### BACKGROUND

### Technical Field

The aspect of the embodiments relates to an image processing technique for reproducing subject blur suited to individual regions while suppressing aggravation of local noise.

### Description of the Related Art

There has been conventionally a technique for image representation by which in a scene of capturing an image of a subject in local motion, a region of representation where motion blur is suppressed and a region of representation where motion blur is left are mixed to enhance the realism of the scene and the liveliness of the subject in motion. In order to provide such image representation, Japanese Patent Application Laid-Open No. 2019-110386 discusses a technique to evaluate information on a moving object from a plurality of time-series consecutive images to determine a motion blur strength, and generate an image with different types of motion blur while changing the number of images to be combined in individual regions.

According to the technique discussed in Japanese Patent Application Laid-Open No. 2019-110386, however, with reference to a plurality of images captured at a predetermined exposure time, the number of images to be combined is decreased for a region where motion blur is to be reduced, whereas the number of images to be combined is increased by averaging for a region where motion blur is to be provided. Accordingly, the subject region where motion blur is to be reduced has much noise relative to the region where motion blur is to be provided, which may deteriorate the quality of the finally obtained image.

### SUMMARY

According to an aspect of the embodiments, an apparatus includes at least one processor and memory that stores a program which, when executed by the at least one processor, cause the at least one processor to function as an image acquisition unit configured to acquire an image, a region determination unit configured to determine a plurality of subject regions in the image, and a combining unit configured to combine a plurality of images obtained by an imaging unit configured to perform image capturing under a predetermined imaging condition, wherein the combining unit has different subject blur correction characteristics corresponding to features of the plurality of subject regions, and performs a combining process with reference to the different subject blur correction characteristics in the plurality of subject regions.

Further features of the disclosure will become apparent from the following description of exemplary embodiments with reference to the attached drawings.

### BRIEF DESCRIPTION OF THE DRAWINGS

FIG. 1 is a diagram for describing a configuration of a digital camera in a first exemplary embodiment.

FIG. 2 is a diagram for describing a configuration of an imaging control parameter generation unit in the first exemplary embodiment.

FIG. 3 is a flowchart for describing operations of the imaging control parameter generation unit in the first exemplary embodiment.

FIG. 4 is a diagram for describing continuously captured images in the first exemplary embodiment.

FIG. 5 is a diagram for describing the effects of superimposition of scene recognition results on display images in the first exemplary embodiment.

FIG. 6 is a flowchart for describing a method for calculating a motion vector in a conventional technique.

FIG. 7 is a diagram for describing the method for calculating a motion vector in the conventional technique.

FIGS. 8A to 8C are diagrams illustrating the superimposition of motion vectors on an image at time t in the first exemplary embodiment.

FIG. 9 is a diagram for describing a correction gain to be applied to the motion vector in the first exemplary embodiment.

FIG. 10 is a diagram for describing a main captured image in the first exemplary embodiment.

### DESCRIPTION OF THE EMBODIMENTS

A first exemplary embodiment of the disclosure will be described in detail with reference to the drawings. The exemplary embodiment described below is an imaging apparatus. An example of application of the disclosure to a digital camera that is an example of the imaging apparatus will be described.

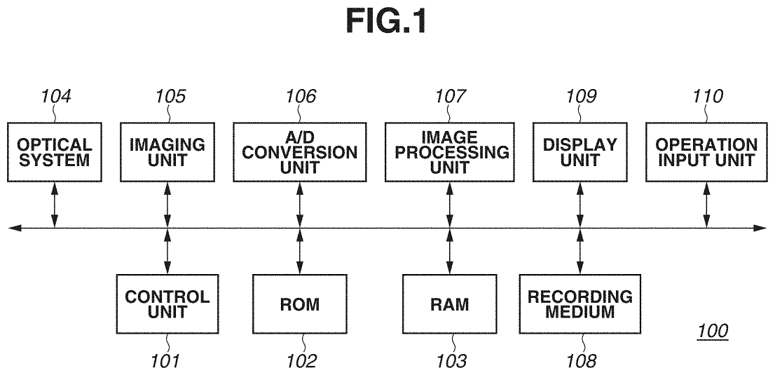

FIG. 1 is a block diagram illustrating a configuration of a digital camera according to the exemplary embodiment of the disclosure.

A control unit 101 is a central processing unit (CPU), for example, which controls operations of blocks included a digital camera 100 by reading operation programs for the blocks from a read only memory (ROM) 102, and developing and executing the operation programs in a random access memory (RAM) 103. The ROM 102 is a rewritable non-volatile memory that stores the operation programs for the blocks in the digital camera 100 and parameters and the like necessary for operations of the blocks. The RAM 103 is a rewritable volatile memory that is used as a temporary storage area of data output by operations of the blocks in the digital camera 100.

An optical system 104 forms an image of a subject on an imaging unit 105. The optical system 104 includes a fixed lens, a magnification lens that changes a focal length, a focus lens that performs a focus adjustment, and others, for example. The optical system 104 also includes a diaphragm, and performs light amount adjustment for image capturing by adjusting the opening diameter of the optical system by the diaphragm. The imaging unit 105 is an imaging element such as a charge-coupled device (CCD) sensor or a complementary metal oxide semiconductor (CMOS) sensor, for example. The imaging unit 105 performs photoelectric conversion on an optical image formed on the imaging element by the optical system 104, and outputs the obtained analog image signal to an analog/digital (A/D) conversion unit 106. The A/D conversion unit 106 performs an A/D conversion process on the input analog image signal, and outputs the obtained digital image data to the RAM 103 for storage, whereby the image data is acquired (image acquisition).

An image processing unit 107 performs various types of image processing such as white balance adjustment, color interpolation, and gamma processing on the image data stored in the RAM 103, and outputs the processed image data to the RAM 103. The image processing unit 107 includes an image combining processing unit 200 described below to recognize a scene of the image data stored in the RAM 103. Besides, the image combining processing unit 200 can generate imaging parameters for the digital camera 100, based on the results of motion analysis using the image data and the results of estimation of the moving direction of the subject. The imaging control parameters generated by the image processing unit 107 are output to the control unit 101 so that the control unit 101 controls the operations of the blocks included in the digital camera 100.

A recording medium 108 is a detachable memory card or the like, which records the images having been processed by the image processing unit 107 and stored in the RAM 103 and the images having been subjected to A/D conversion by the A/D conversion unit 106, as recording images. A display unit 109 is a display device such as a liquid display device (LCD) that can implement an electronic view-finder function by performing live view display of the subject images captured by the imaging unit 105. The display unit 109 provides various kinds of information in the digital camera 100, by replaying and displaying the images recorded on the recording medium 108. The display unit 109 can also superimpose icons on the images based on the results of scene recognition of the image data by the image processing unit 107.

An operation input unit 110 includes user input interfaces such as a release switch, a setting button, and a mode setting dial, for example. Upon detection of an operation input performed by the user, the operation input unit 110 outputs a control signal corresponding to the operation input, to the control unit 101. In a mode where the display unit 109 includes a touch panel sensor, the operation input unit 110 also functions as an interface that detects a touch operation performed on the display unit 109.

As above, the configuration and basic operations of the digital camera 100 have been described.

The operation of the image processing unit 107 that is a feature of the first exemplary embodiment will be described, taking the imaging of a subject who is swinging a golf club as an example. Herein, description will be given as to a process for obtaining an image without aggravation of local noise while performing different motion blur controls in the individual regions such that motion blur does not appear in the region of the subject's face but motion blur appears in the region of the subject's golf swing.

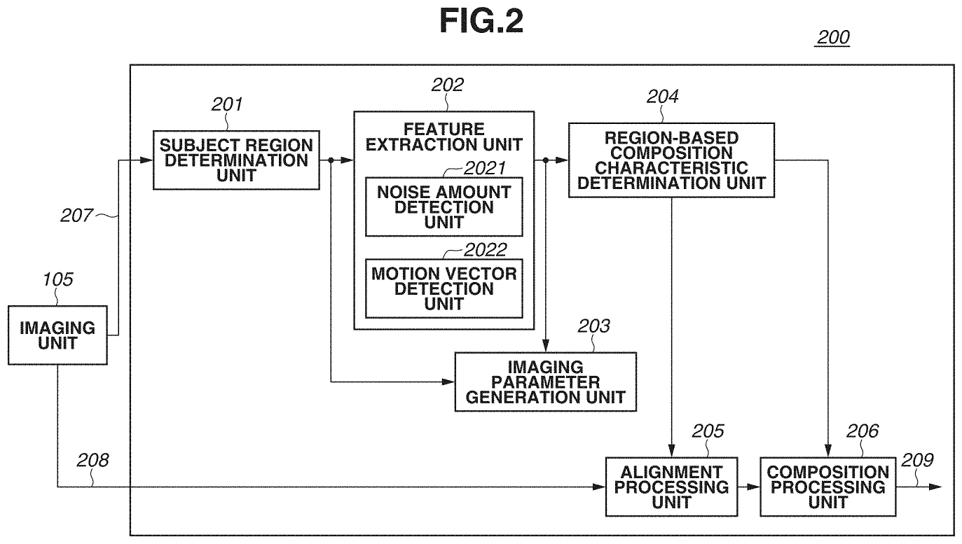

A configuration example of the image combining processing unit 200 included in the image processing unit 107 will be described with reference to FIG. 2. FIG. 2 is a diagram illustrating a configuration example of the image combining processing unit 200.

The image combining processing unit 200 includes a subject region determination processing unit 201, a feature extraction unit 202, an imaging parameter generation unit 203, a region-based combining characteristic determination unit 204, an alignment processing unit 205, and a combining n processing unit 206. The image combining processing unit 200 accepts an input of image data 207 and 208 captured by the imaging unit 105 and recorded on the RAM 103, and outputs an image combining result 209.

The image data 207 represents images captured during a live view operation for the user to determine the imaging timing while recognizing the subject in preparation for image capturing. The image data 208 represents images captured during main image capturing in response to an imaging instruction issued by the user. The same imaging control may be performed at the times of capturing the image data 207 and 208. Alternatively, the imaging control may be changed at the time of capturing the image data 208 based on imaging parameters including aperture, shutter speed, and International Organization for Standardization (ISO) sensitivity which are determined by the imaging parameter generation unit 203 during the live view operation.

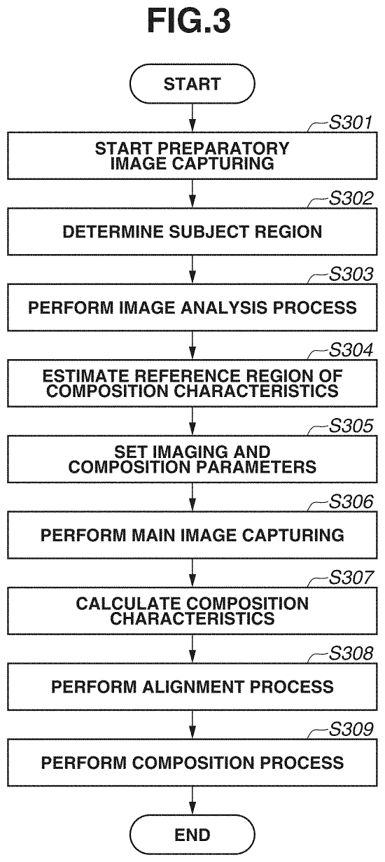

The process performed by the image combining processing unit 200 will be described with reference to the flowchart in FIG. 3. The steps described in the flowchart are executed by the control unit 101 or the components of the digital camera 100 in response to an instruction from the control unit 101.

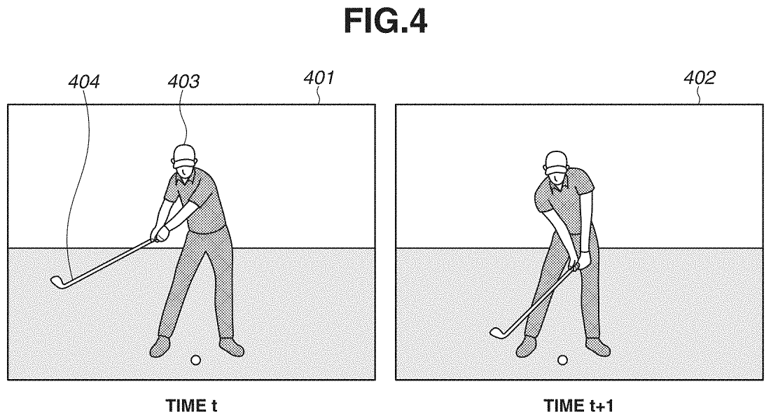

In step S301, the user powers on the digital camera 100, and starts preparatory imaging such as combining adjustment. During the preparatory imaging, the control unit 101 continuously captures images while maintaining a predetermined frame rate. When the captured images are displayed on the display unit 109, the user performs combining adjustment and the like while watching the displayed images. In the present exemplary embodiment, the frame rate is 120 images per second. That is, the imaging unit 105 captures one image every 1/120 second. The shutter speed here is set as high as possible. FIG. 4 illustrates an example of continuously captured images. An image 401 is captured at time t, and an image 402 is captured at time t+1. FIG. 4 illustrates the capturing of images of a person who is swinging a golf club. The amount of motion of the subject is small in the regions of the face and center of body of a person 403. The amount of motion of the subject is large in a region 404 of an end of the golf club, but no large blur occurs in the captured image because the exposure time is short.

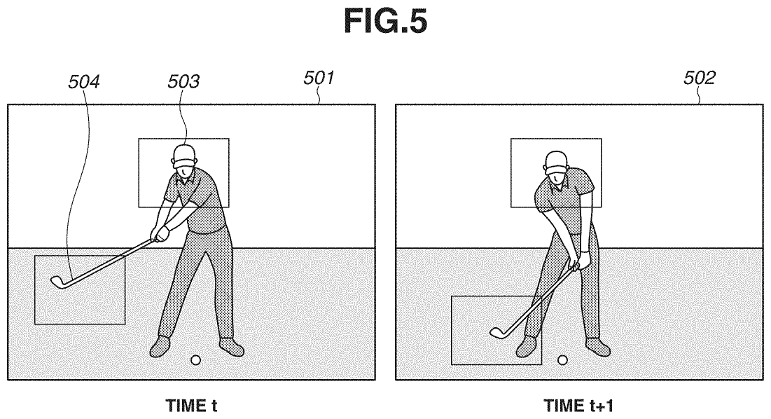

In step S302, under control of the control unit 101, the subject region determination unit 201 refers to the image data 207 captured (acquired) in step S301 to determine representative subject regions that are references for determining reproducibility of motion blur and noise in a final output image. For example, in the golf scene in the present exemplary embodiment, as illustrated in FIG. 5, the region of the face of the person playing golf is set to a first representative subject region 503, and the region of the end of the swung golf club and its vicinity is set to a second representative subject region 504.

As an example of a method for determining a subject region, the user determines a predetermined region by touching the captured image displayed on the display unit while watching the captured image displayed on the display unit. Specifically, during preparation for imaging, when the user touches part of the image on the display unit, rectangular frames 503 and 504 of a predetermined size including the touched region is superimposed on the image. A known image recognition process such as machine learning is performed on the region in the image to identify the attributes of the set subject region. A plurality of subject regions may be determined by setting a person subject and a subject of a specific sport such as golf as detection targets, according to the technique discussed in Japanese Patent Application Laid-Open No. 2002-77711, for example.

In either case, the attributes of the region information determined by the subject region determination unit 201, for example, information on a person region, a golf club, and the like, are held in the RAM 103 as information on a plurality of representative subject regions.

In step S303, under control of the control unit 101, the feature extraction unit 202 refers to the image data 207 to calculate the image feature amounts for determining the combining characteristics in the individual regions from the features of the image in the subject region selected in step S302. The present exemplary embodiment is intended to control the combining characteristics based on the amounts of motion and noise in the subject region, thereby to produce a final output image so as to represent the liveliness of the moving subject region while reproducing noise in the still subject region at a preferred level. Accordingly, the feature extraction unit 202 includes a motion vector calculation unit 2022 and a noise amount calculation unit 2021 as illustrated in FIG. 2, which determine motion vector information and noise amount, respectively, as the image feature amounts in the selected regions.

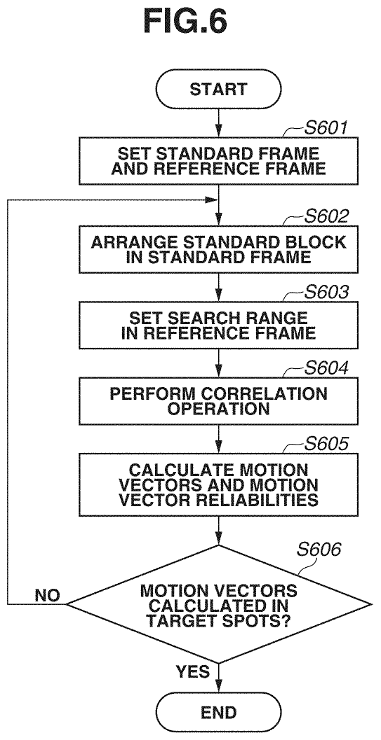

A motion vector calculation process by the motion vector calculation unit 2022 will be described in detail with reference to FIGS. 6 to 8.

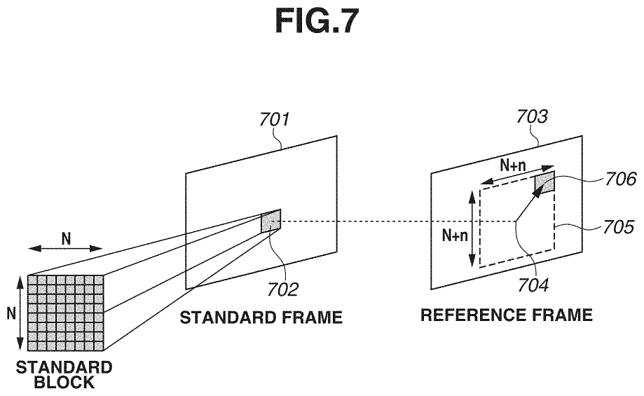

The motion vector is a representation of the amount of movement in the horizontal direction and the amount of movement in the vertical direction of the subject region between the images 207 continuously captured. FIG. 6 is a flowchart of a calculation process of motion vector and motion vector reliability by the motion vector calculation unit 2022. FIG. 7 is a diagram illustrating a method for calculating a motion vector by block matching. In the present exemplary embodiment, as a method for calculating a motion vector, the block matching method is taken as an example. The method for calculating a motion vector is, however, not limited to this example, and may be a gradient method, for example.

In step S601 of FIG. 6, two captured images, which are temporally adjacent to each other, are input into the motion vector calculation unit 2022. In the present exemplary embodiment, the motion vector calculation unit 2022 sets the image captured at time t illustrated in FIG. 4 as a standard frame, and sets the image captured at time t+1 as a reference frame.

In step S602 of FIG. 6, the motion vector calculation unit 2022 arranges a standard block 702 of N×N pixels in a standard frame 701 as illustrated in FIG. 7.

In the present exemplary embodiment, because the region where the standard block 702 is to be arranged is set to the representative subject region determined by the subject region determination unit 201 in step S302, it is possible to efficiently analyze only the motion information necessary for generating the imaging parameters. In particular, because a correlation calculation in step S604 described below has a heavy processing load, performing the calculation only in the necessary region enables high-speed generation of the imaging parameters.

In step S603 of FIG. 6, the motion vector calculation unit 2022 sets surrounding (N+n)×(N+n) pixels at the same coordinates 704 as the central coordinates of the standard block 702 in the standard frame 701, as a search range 705 in a reference frame 703 as illustrated in FIG. 7. As in step S602, the setting of the search range 705 is limited to the surroundings of the representative subject region determined by the subject region determination processing unit 201.

In step S604 of FIG. 6, the motion vector calculation unit 2022 performs a correlation calculation on the standard block 702 in the standard frame 701 and a reference block 706 of N×N pixels at different coordinates existing within the search range 705 in the reference frame 703 to calculate a correlation value. The correlation value is calculated based on the sum of inter-frame difference absolute values with respect to the pixels in the standard block 702 and reference block 706. That is, the coordinates with the least inter-frame difference absolute value constitute the coordinates with the highest correlation value. The method for calculating a correlation value is not limited to the method to determine the sum of inter-frame difference absolute values, and may be a method for calculating the correlation value based on the sum of squares of inter-frame difference or the normalized cross-correlation value. In the example of FIG. 7, the reference block 706 exhibits the highest correlation.

In step S605 of FIG. 6, the motion vector calculation unit 2022 calculates the motion vector based on the reference block coordinates with the highest correlation value determined in step S604, and sets the correlation value of the motion vector as motion vector reliability. In the example of FIG. 7, in the search range 705 of the reference frame 703, the motion vector is determined based on the coordinates 704 corresponding to the central coordinates of the standard block 702 in the standard frame 701 and the central coordinates of the reference block 706. That is, the inter-coordinate distance and direction from the coordinates 704 to the central coordinates of the reference block 706 are determined as motion vector. The correlation value, which is the result of correlation calculation with the reference block 706 at the time of calculation of the motion vector is determined as motion vector reliability. The motion vector reliability is higher with a higher value of correlation between the standard block and the reference block.

In step S606 of FIG. 6, the motion vector calculation unit 2022 determines whether the motion vector has been calculated in the target locations where the standard block 702 is to be arranged in the standard frame 701, that is, in the present exemplary embodiment, in the representative subject regions set by the subject region determination processing unit 201. In a case where the motion vector calculation unit 2022 determines that the motion vector has been calculated in all the target locations (YES in step S606), the process of motion vector calculation is ended. On the other hand, in a case where the subject region determination processing unit 201 determines that the motion vector has not yet been calculated in all the target locations (NO in step S606), the process returns to step S602, and the subsequent steps are repeated. In the present exemplary embodiment, in the standard block 702, the motion vector and the motion vector reliability are calculated in every pixel included in the face region and golf club region, and the motion vectors with high reliability are averaged based on the motion vector reliabilities to determine the representative motion vectors in the corresponding regions.

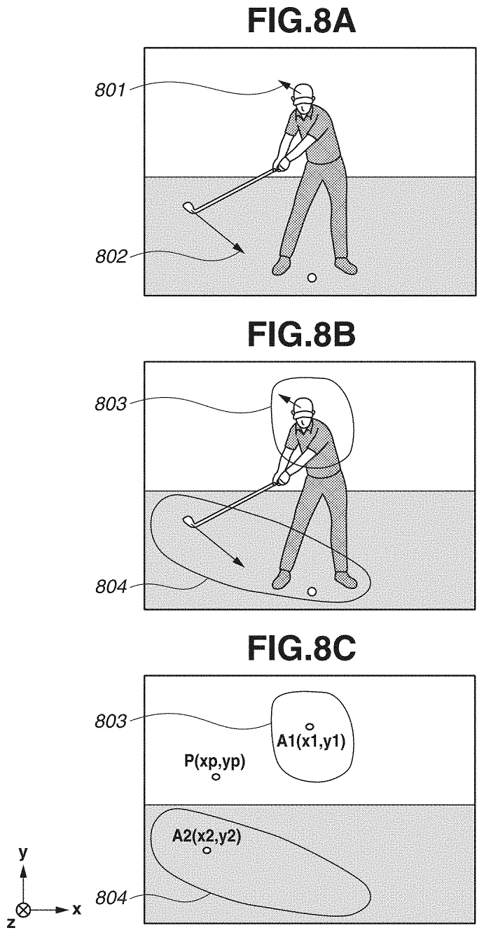

FIG. 8A illustrates motion vectors between captured images that are calculated in the above-described process. The arrows in FIG. 8A indicate the motion vectors, the lengths of the arrows indicate the magnitudes of the motion vectors, and the directions of the arrows indicate the directions of the motion vectors. A motion vector 801 is the motion vector of the face region of a person subject 403, and a motion vector 802 is the motion vector of the region of a golf club. It can be seen that because the golf club is swung at a high speed, the amount of movement between the frames in the golf club region is larger than the amount of movement in the face region.

A noise amount calculation process by the noise amount calculation unit 2021 will be described.

The noise amount calculation unit 2021 refers to the pixel values in the representative subject regions of the image data 207 set by the subject region determination processing unit 201 in step S302, and calculates the variances of the pixel values in the regions as noise amounts. Specifically, noise amounts N(A1) and N(A2) corresponding to the first representative subject region 503 and the second representative subject region 504 are calculated based on the following equations (1) and (2), respectively:

N(A1)=1/n1Σ(xi1−x_ave1)\hat{ }2 (1)

N(A2)=1/n2Σ(xi2−x_ave2)\hat{ }2 (2)

In the equations, n1 and n2 are the numbers of pixels in the corresponding representative subject regions, xi1 and xi2 are pixel values in the corresponding representative subject regions, and x1_ave and x2_ave are the average values of pixels in the corresponding representative subject regions.

The motion vector information and noise amounts in the individual representative subject regions calculated in step S303 are used to determine the number of images to be combined in a subsequent combining process.

In step S304, under the control of the control unit 101, the region-based combining characteristic determination unit 204 performs a process of estimating reference regions for determining the characteristics of the combining process during the main image capturing based on the amounts of features of the images in the representative subject regions. First, the region-based combining characteristic determination unit 204 estimates regions where the amount of motion seeming as being the same degree as those in the representative subject regions will be generated during the main imaging, among regions in the vicinity of the representative subject regions, from the attributes of the representative subject regions determined in step S302 and the motion vector amounts and directions in the representative subject regions calculated in step S303. This process may be performed with the application of a known recognition process such as machine learning. Based on the attributes of the representative subject regions, the corresponding points of the motion vectors may be extended for a predetermined period of time such that the motions in the representative subject regions continuously occur in the directions of the motion vectors to estimate regions where a predetermined amounts of motion will occur. FIG. 8B illustrates an example of estimated regions. A first reference region 803 is a region that corresponds to the first representative subject region 503 and where it is estimated that the same degree of amount of motion as the motion of the face of the person subject will occur. A second reference region 804 is a region that corresponds to the second representative subject region 504 and where it is estimated that the amount of motion at the time of a high-speed swing of the golf club will occur. These estimated regions are referred to as reference regions for determining the characteristics of different combining processes in the individual regions at a subsequent stage. For each of the reference regions, the name of the reference region and the information on the pixel positions of a representative point in the reference region are stored in the RAM 103 in association with each other. As an example of a representative point in the reference region, the motion vector at each pixel position in the reference region is referred to, and the region with the largest magnitude of motion or the region with the smallest magnitude of motion is set as a representative point. FIG. 8C illustrates an example of reference regions and representative points. The first reference region 803 in the scene of FIG. 8B has a representative point A1 and its coordinates are A1(x1, y1). The second reference region 804 in the scene of FIG. 8B has a representative point A2 and its coordinates are A2(x2, y2).

In step S305, based on the feature amounts of the image in the representative subject regions analyzed in step S303, the imaging parameter generation unit 203 determines the imaging parameters to be applied to the main image capturing under the control of the control unit 101 (imaging condition determination). Specifically, the imaging parameter generation unit 203 determines the shutter speed, the aperture value, the setting of ISO sensitivity, the total exposure time for obtaining the final output image, and the number of images to be combined in the combining process. The shutter speed here is set to a high shutter speed so as to reduce the blur of the face region that is the first representative subject region. The aperture value is set to an aperture value with which the first representative subject region and the region of the swung golf club that is the second representative subject region fall within the depth of field. The ISO sensitivity is set such that the level of average brightness in the screen including the first representative subject region and the second representative subject region becomes a predetermined level under the above-described conditions of shutter speed and aperture value. The total exposure time for obtaining the final output image is determined with reference to the information on the motion vectors and noise amounts determined in step S303, based on the exposure time for which the motion blur in the second representative subject region reaches the desired amount of motion blur and the noise amount is suppressed in the first representative subject region where blur is to be less reproduced. The value obtained by dividing the total exposure time by the shutter speed indicates the number of captured images that are to be used for combining.

In step S306, based on the imaging parameters determined in step S305, the imaging unit 105 performs the main image capturing for generating the final output image to obtain images 208 to be used for the final output image.

For example, ten images are continuously captured at a shutter speed of 1/500 second, with an aperture value of F8, and with an ISO sensitivity of 12800, for example. The driving of the imaging unit 105 is controlled such that the intervals between the captured frames of the consecutive images are as short as possible.

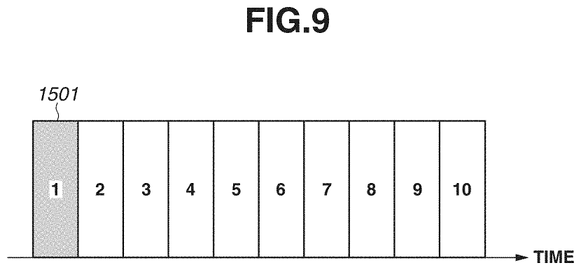

FIG. 9 is a diagram illustrating the order of the images 208 continuously captured. In a subsequent alignment process, a beginning image 1501 is set as a reference for alignment. Alternatively, based on the amounts of motion in the representative subject regions, an image other than the beginning image may be set as a reference for alignment.

In step S307, the region-based combining characteristic determination unit 204 refers to the attribute information of the reference region and performs a process of calculating the combining characteristics at each pixel position under the control of the control unit 101.

The images 208 continuously captured in step S306 are input in sequence. At each pixel position in the images, the region-based combining characteristic determination unit 204 determines to which region among the plurality of reference regions the pixel corresponds, based on the distance between the pixels. As illustrated in FIG. 8C, the pixel position of the representative point in the first reference region is designated as A1(X1, Y1), the pixel position of the representative point in the second reference region is designated as A2(X2, Y2), and the pixel position of a focused pixel P in the input image is designated as P(Xp, Yp). At this time, an inter-pixel distance D1 between the pixel P and the first reference region and an inter-pixel distance D2 between the pixel P and the second reference region are calculated by the following equations (3) and (4):

D1=|Xp−X1|+|Yp−Y1| (3)

D2=|Xp−X1|+|Yp−Y1| (4)

The region-based combining characteristic determination unit 204 refers to the inter-pixel distances D1 and D2 and a predetermined threshold THmin to calculate a combining index M for controlling the combining characteristics in the focused pixel by the following equations (5) to (8):

M=0(D1<D2 and D1<THmin) (5)

M=1023(D2<D1 and D2<THmin) (6)

M=D1/(D1+D2)(D1<D2 and D1>THmin) (7)

M=1023−D2/(D1+D2)(D2<D1 and D2>THmin) (8)

For example, in a case where the focused pixel P is located at a pixel position included in the first reference region 803, the combining index M is set to 0 by the equation (5). On the other hand, in a case where the focused pixel P is located at a pixel position included in the second reference region 804, the combining index M is set to 1023 by the equation (6). As illustrated in FIG. 8C, if the focused pixel P is located in an intermediate pixel region not included in the first reference region 803 or the second reference region 804, the combining index M is set to a value between 1 to 1023 by the equation (7) or (8).

In accordance with the combining index M for each pixel calculated as described above, the degree of application of the combining process based on the first reference region 803 is made higher to the pixels closer to the representative point of the first reference region 803 in the subsequent combining process. On the other hand, the subsequent alignment process and combining process are controlled such that the degree of application of the combining process based on the second reference region 804 is made higher with respect to the pixels closer to the representative point of the second reference region 804.

The aim of changing the characteristics of the combining process among the regions will be described.

In a case where an image is to be captured in a dim environment, the ISO sensitivity may be high if a high shutter speed is set such that the representative subject region ion of an imaging target falls within the depth of field and the face region does not appear blurred. For example, the shutter speed is 1/500 second, the aperture value is F8, and the ISO sensitivity is 12800. In order to generate an image in which the motion blur in the motion region is reproduced and the noise in the still image is less reproduced using a plurality of images captured under the conditions described above, the plurality of images is to be combined even in the still region. A failure to do so will relatively worsen the noise level in the still region.

For example, in a case where a desired level of motion blur can be achieved at 1/50 second, ten images captured at 1/500 second are averaged, and in the motion region, the noise level of the image after the combining (averaging) is attenuated to 1√10. For this reason, even in the subject region where motion blur is to be suppressed, the same degree of averaging is to be performed to reduce the noise level. A failure to do so will generate a noise difference at the boundary between the motion region and the still region to deteriorate the image quality. In the still region, the combining process is to be performed after correction of local positional shifts in the image due to camera-shake blur and minute subject blur. In the region where motion is to be reproduced, the combining process is to be performed with camera-shake blur being corrected but local subject blur being not corrected. Accordingly, in the disclosure, the combining process is performed with different correction characteristics in each region of the image such that the reproduction of blur and the suppression of noise reach desired degrees.

In step S308, prior to the combining, based on the combining characteristics determined in step S307, the alignment processing unit 205 determines the amount of correction of the positional shift at each pixel position and performs an alignment (position correction) process under the control of the control unit 101.

The pixels to which the combining characteristic index M of 0 to 511 has been set in step S307 are pixels in the vicinity of the first reference region 803. Accordingly, the alignment processing unit 205 detects a camera-shake component and local image blur of the subject and performs alignment so as to reduce the blur of the face in the first representative subject region. On the other hand, the pixels to which the combining characteristic index M of 512 to 1023 has been set in step S307 are pixels in the vicinity of the second reference region 804. Accordingly, the alignment processing unit 205 performs alignment correction based on the camera-shake component alone, that is, the amount of positional shift at angle of view of the entire image so as to reproduce the motion blur in the region of a golf swing that is the second representative subject region. As a specific example of the alignment process, the publicly known technique discussed in Japanese Patent Application Laid-Open No. 2009-104228 can be applied, but the alignment process is not limited to this example.

In step S309, the combining processing unit 206 performs the combining process at each pixel position based on the combining characteristics determined in step S307 under the control of the control unit 101. The combining processing unit 206 uses the pixels to which the combining characteristic index M=0 to 511 has been applied in step S307 to reduce the blur of the face in the first representative subject region, and refers to the images to which the alignment has been performed in step S308 to average a predetermined number of images, giving priority to the combining characteristics for reducing the noise. With reference to the noise amounts calculated in step S303, in the images before the combining, the noise amount in the first representative subject region may be larger than the noise amount in the second representative subject region. In this case, since performing the averaging that is equivalent to the averaging for reproducing the motion blur will increase the noise difference, a smoothing process may be performed on the combined image for each pixel with reference to the image of the vicinity of the focused pixel.

For the pixels to which the combining characteristic index M of 512 to 1023 has been set in step S307, the combining processing unit 206 gives a higher priority to the reproduction of the motion blur in the region of a golf swing that is the second representative subject region. Thus, the combining processing unit 206 averages a predetermined number of images with reference to the images that have been aligned differently from that in the first representative subject region in step S308.

The above processes are performed at all the pixel positions of the main images 208 continuously captured, and the output result is recorded on the recording medium 108, and then the series of processes is ended.

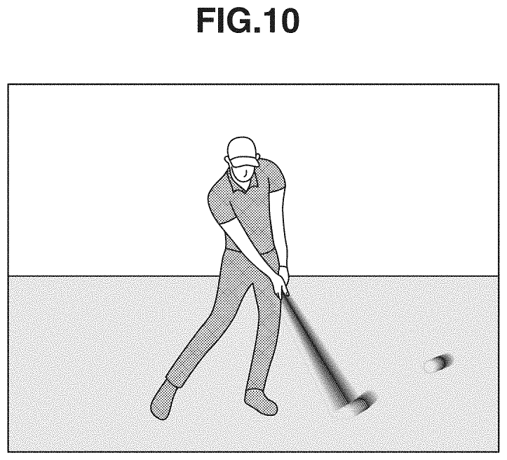

FIG. 10 illustrates an example of the output image. No motion blur is generated at the face portion of the person subject, and some motion blur is generated in the golf club region. Accordingly, an image with liveliness can be captured.

As described above, in capturing an image with a mixture of a region where motion blur is to be maintained and a region where motion blur is to be suppressed, it is possible to reproduce subject motion suited to individual regions while suppressing aggravation of local noise.

Exemplary embodiments of the disclosure have been described. However, the disclosure is not limited to these exemplary embodiments and can be modified and changed in various manners within the scope of the gist of the disclosure.

The disclosure can be carried out by a process of supplying a program for implementing one or more functions of the above-described exemplary embodiments to a system or apparatus via a network or a recording medium and causing one or more processor in the system or apparatus to read and execute the program. The disclosure can be carried out by a circuit that implements one or more functions (for example, an application specific integrated circuit (ASIC)).

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-030258, filed Feb. 28, 2022, which is hereby incorporated by reference herein in its entirety.

What is claimed is:

1. An apparatus comprising:
at least one processor; and
a memory that stores a program which, when executed by the at least one processor, causes the at least one processor to function as:
an acquisition unit configured to acquire an image;
a region determination unit configured to determine a plurality of subject regions in the image; and
a combining unit configured to combine a plurality of images obtained by an imaging unit configured to perform image capturing under a predetermined imaging condition,
wherein the combining unit has different subject blur correction characteristics corresponding to features of the plurality of subject regions, and performs a combining process with reference to the different subject blur correction characteristics in the plurality of subject regions.

2. The apparatus according to claim 1, wherein the features of the plurality of subject regions are determined based on at least one of motion amounts and noise amounts in the plurality of subject regions.

3. The apparatus according to claim 1, further comprising an imaging condition determination unit configured to determine the predetermined imaging condition,
wherein the imaging condition determination unit determines an exposure time and a number of images to be combined corresponding to the different subject blur correction characteristics for each of the plurality of subject regions based on attributes of the plurality of subject regions in the image and amounts of motion in the plurality of subject regions.

4. The apparatus according to claim 3, wherein the attributes of the subject regions are discriminated by a recognition process.

5. The apparatus according to claim 1, wherein the combining unit includes a position correction unit configured to correct a local positional shift between a plurality of images.

6. The apparatus according to claim 5, wherein the combining unit combines the plurality of images after the local positional shift is corrected by the position correction unit.

7. The apparatus according to claim 6, wherein the position correction unit determines the amount of correction of the local positional shift based on at least any of the features of the images in a first subject region and a subject region adjacent to the first subject region.

8. The apparatus according to claim 1, wherein the combining unit determines a number of images to be combined based on a difference of noise level between the first subject region and the subject region adjacent to the first subject region.

9. The apparatus according to claim 7, wherein the first subject region is a region where subject blur is to be suppressed among the plurality of subject regions.

10. The apparatus according to claim 7, wherein the first subject region is a region where subject blur is to be reproduced among the plurality of subject regions.

11. The apparatus according to claim 1, wherein the plurality of subject regions is determined based on a feature amount of the image.

12. The apparatus according to claim 1, wherein the predetermined imaging condition includes at least one of shutter speed, aperture value, International Organization for Standardization (ISO) sensitivity, exposure time, and a number of images to be combined.

13. The apparatus according to claim 1, further comprising a display unit configured to display the image, wherein the plurality of subject regions is determined by a user on the display unit.

14. An imaging apparatus comprising:
an imaging unit configured to capture a subject image formed via an optical system and output the image; and
the apparatus according to claim 1.

15. A method of an apparatus, the method comprising:
acquiring an image;
determining a plurality of subject regions in the image; and
combining a plurality of images obtained by an imaging unit configured to perform image capturing under a predetermined imaging condition,
wherein the combining has different subject blur correction characteristics corresponding to features of the plurality of subject regions and includes performing a combining process with reference to the different subject blur correction characteristics in the plurality of subject regions.

16. The method according to claim 15, wherein the features of the plurality of subject regions are determined based on at least one of motion amounts and noise amounts in the plurality of subject regions.

17. The method according to claim 15, further comprising determining the predetermined imaging condition,
wherein the determining determines an exposure time and a number of images to be combined corresponding to the different subject blur correction characteristics for each of the plurality of subject regions based on attributes of the plurality of subject regions in the image and amounts of motion in the plurality of subject regions.

18. A computer-readable storage medium storing a program which makes a computer execute a method, the method comprising:
acquiring an image;
determining a plurality of subject regions in the image; and
combining a plurality of images obtained by an imaging unit configured to perform image capturing under a predetermined imaging condition,
wherein the combining has different subject blur correction characteristics corresponding to features of the plurality of subject regions and includes performing a combining process with reference to the different subject blur correction characteristics in the plurality of subject regions.

19. The computer-readable storage medium according to claim 18, wherein the features of the plurality of subject regions are determined based on at least one of motion amounts and noise amounts in the plurality of subject regions.

20. The computer-readable storage medium according to claim 18, further comprising determining the predetermined imaging condition,
wherein the determining determines an exposure time and a number of images to be combined corresponding to the different subject blur correction characteristics for each of the plurality of subject regions based on attributes of the plurality of subject regions in the image and amounts of motion in the plurality of subject regions.
